(19) United States
(12) Patent Application Publication
(10) Pub. No.: US 2016/0190822 A1
(43) Pub. Date: Jun. 30, 2016

(54) MICROGRID ENERGY MANAGEMENT SYSTEM AND POWER STORAGE METHOD FOR ENERGY STORAGE SYSTEM

(71) Applicant: LG CNS CO., LTD., Seoul (KR)

(72) Inventors: Jeong Hwan LEE, Seoul (KR); Gun Dong PARK, Seoul (KR); Hyunah LEE, Seoul (KR)

(73) Assignee: LG CNS CO., LTD., Seoul (KR)

(21) Appl. No.: 14/586,429

(22) Filed: Dec. 30, 2014

(51) Int. Cl. H02J 7/00; H02J 9/06

(52) U.S. Cl. CPC H02J 7/007; H02J 7/0052; H02J 9/06; H02J 7/0013

(57) ABSTRACT

A power storage method for an energy storage system (ESS) is provided. The method includes determining a total quantity of power currently available in a power supply and a quantity of power currently required by a plurality of loads, determining a quantity of residual power currently available based on the total quantity of power currently available and the quantity of power currently required, and charging an ESS of a load determined as having a highest priority with the total power currently available while charging other ESSs of other loads with the residual power currently available.

### FIELD OF THE INVENTION

The present invention relates to a microgrid energy management system and a power storage method for an energy storage system (ESS) and, more particularly, to a microgrid energy management system and a power storage method that selectively charges an ESS with residual power such that power is stably supplied to a load having a high priority.

### DISCUSSION OF RELATED ART

Traditional power generation equipment, such as traditional thermal power, cause environmental problems and increased power generation costs due to limitations of resources and the like. Therefore, there is a high demand for a power supply system that utilizes new renewable energy sources, such as wind power, solar power, tidal power that are expensive to install but incur small operation and maintenance costs.

A microgrid is a type of a power distribution method that includes a distributed power supply and an energy storage system (ESS). A microgrid performs a method to control supply and demand for power within a small-sized electric power supply source.

Loads in a microgrid are operated in a system linkage operation mode such that the loads are primarily operated by a system power source. However, in a situation such as power failure or system malfunction, the microgrid should be independently operated. For independent operation, the microgrid includes a distributed power supply based on a new renewable energy source and an ESS that stores the distributed power supply. The ESS stores energy produced from the new renewable energy source, but also supplies power stored in loads when an emergency situation of the system power source occurs, such as power failure or the like. The ESS should be charged to at least a certain degree in order to stably supply power to the load even in the emergency situation.

Furthermore, loads in the microgrid may be divided into several classifications. For example, there may be a high-priority load to which power should be constantly supplied and a low-priority load to which power may not be supplied in an emergency.

There is no problem if the charged power quantity of the ESS is sufficient to operate all loads in an emergency, with the charged power of the ESS otherwise efficiently used. For example, power should be stored in the ESS and discharge of the ESS should be controlled such that power may be stably supplied to the high-priority load even in an emergency.

However, stable operation of the high-priority load via control of a state of discharge (SoD) of the ESS in an emergency is performed retroactively and, therefore, control of the SoD of the ESS is not easy. There is a demand for technology in which the residual power of the microgrid is efficiently stored in the ESS such that power may be stably supplied to a high-priority load when an emergency situation occurs.

### SUMMARY OF THE INVENTION

In a first aspect of the invention, a power distribution method for an energy management system (EMS) is provided. The method includes determining a total quantity of power currently available in a power supply, determining a quantity of power currently required by a plurality of loads each associated an energy storage system (ESS) of a plurality of energy storage systems ESSs, determining a quantity of residual power currently available based on the total quantity of power currently available and the quantity of power currently required and charging the ESS associated with one of the plurality of loads determined as having a highest priority with the total power currently available while charging other ESSs associated with the other of the plurality of loads with the residual power currently available.

It is contemplated that charging the other ESSs includes determining an ESS associated with the other of the plurality of loads that has a state of charge (SoC) less than a minimum allowable SoC and charging the determined ESS first with the residual power currently available. It is further contemplated that the method further includes determining a priority for each of the plurality of loads and sequentially charging the ESS associated with each of the plurality of loads according to the determined priority.

It is contemplated that sequentially charging the ESS includes charging a first ESS associated with a load of the plurality of loads determined as having a highest priority and charging the ESSs associated with the other loads of the plurality of loads determined as having lower priorities after a state of charge (SoC) of the first ESS reaches a predetermined minimum value. It is further contemplated that sequentially charging the ESS includes charging an ESS associated with a load of the plurality of loads determined as having a highest priority with a higher percentage of the residual power currently available by allocating the residual power according to a fixed ratio.

It is contemplated that the plurality of loads consist of a high-priority load, a general load and a low-priority load and the fixed ratio allocates 50% of the residual power currently available to the high priority load, allocates 30% of the residual power currently available to the general load and allocates 20% of the residual power currently available to the low-priority load. It is further contemplated that sequentially charging the ESS includes charging the ESS associated with a load of the plurality of loads determined as having a highest priority such that the ESS has a higher state of charge (SoC) than ESSs associated with the other of the plurality of loads.

It is contemplated that determining the quantity of residual power currently available includes determining that the total quantity of power currently available exceeds the quantity of power currently required by at least a threshold value. It is further contemplated that the method further includes switching the plurality of ESSs to a discharge mode or maintaining the plurality of ESSs at a current charge level when it is determined that no quantity of residual power is currently available. Moreover, it is contemplated that the discharge mode includes determining that a charge level of the ESS associated with one of the plurality of loads determined as having the highest priority is insufficient and allocating power of at least one ESS associated with another of the plurality of loads determined as having a lower priority to charge the ESS associated with the one of the plurality of loads determined as having the highest priority.

In another aspect of the present invention, a microgrid energy measurement system is provided. The system includes a power determination apparatus configured to determine a total quantity of power currently available in a power supply, a power consumption determination apparatus configured to determine a quantity of power currently required by a plurality of loads each associated an energy storage system (ESS) of a plurality of energy storage systems ESSs, a residual power determination apparatus configured to determine a quantity of residual power currently available based on the total quantity of power currently available and the quantity of power currently required and a control apparatus configured to charge the ESS associated with one of the plurality of loads determined as having a highest priority with the total power currently available while charging other ESSs associated with the other of the plurality of loads with the residual power currently available.

It is contemplated that the system further includes a state of charge (SoC) apparatus configured to determine an ESS associated with the other of the plurality of loads that has an SoC less than a minimum allowable SoC, where the control apparatus is further configured to charge the determined ESS first with the residual power currently available. It is further contemplated that the control apparatus is further configured to determine a priority for each of the plurality of loads and sequentially charge the ESS associated with each of the plurality of loads according to the determined priority.

It is contemplated that sequentially charging the ESS includes charging a first ESS associated with a load of the plurality of loads determined as having a highest priority and charging the ESSs associated with the other loads of the plurality of loads determined as having lower priorities after a state of charge (SoC) of the first ESS reaches a predetermined minimum value. It is further contemplated that sequentially charging the ESS includes charging the ESS associated with a load of the plurality of loads determined as a highest priority with a higher percentage of the residual power currently available by dividing the residual power according to a fixed ratio.

It is contemplated that the plurality of loads consist of a high-priority load, a general load and a low-priority load and the fixed ratio allocates 50% of the residual power currently available to the high priority load, allocates 30% of the residual power currently available to the general load and allocates 20% of the residual power currently available to the low-priority load. It is further contemplated that sequentially charging the ESS includes charging the ESS associated with a load of the plurality of loads determined as having a highest priority such that the ESS has a higher state of charge (SoC) than ESSs associated with the other of the plurality of loads.

It is contemplated that determining the quantity of residual power currently available includes determining that the total quantity of power currently available exceeds the quantity of power currently required by at least a threshold value. It is further contemplated that the control apparatus is further configured to switch the plurality of ESSs to a discharge mode or maintain the plurality of ESSs at a current charge level when it is determined that no quantity of residual power is currently available. Moreover, it is contemplated that the discharge mode includes determining that a charge level a of the ESS associated with one of plurality of loads determined as having the highest priority is insufficient and allocating power of at least one ESS associated with another of the plurality of loads determined as having a lower priority to charge the ESS associated with the one of the plurality of loads determined as having the highest priority.

### BRIEF DESCRIPTION OF THE DRAWINGS

The above and other objects, features and advantages of the present invention will become more apparent to those of ordinary skill in the art by describing in detail exemplary embodiments thereof with reference to the accompanying drawings, in which:

FIG. 1 is a schematic configuration diagram illustrating a microgrid system according to an embodiment of the present invention;

FIG. 2 is a diagram illustrating a detailed configuration of an energy management system according to an embodiment of the present invention; and

FIG. 3 is a flowchart illustrating a power storage method for an energy storage system (ESS) according to an embodiment of the present invention.

### DETAILED DESCRIPTION OF THE EMBODIMENTS

Example embodiments of the present invention are disclosed herein. However, specific structural and functional details disclosed herein are merely representative for purposes of describing example embodiments of the present invention. Example embodiments of the present invention may be embodied in many alternate forms and should not be construed as being limited to the example embodiments of the present invention set forth herein.

Accordingly, while the invention is capable of various modifications and alternative forms, specific embodiments are shown by way of example in the drawings and will be described in detail. It should be understood, however, that there is no intent to limit the invention to the particular forms disclosed, but on the contrary, the invention is to cover all modifications, equivalents, and alternatives falling within the spirit and scope of the invention. Like numbers in the figures refer to like elements throughout the description.

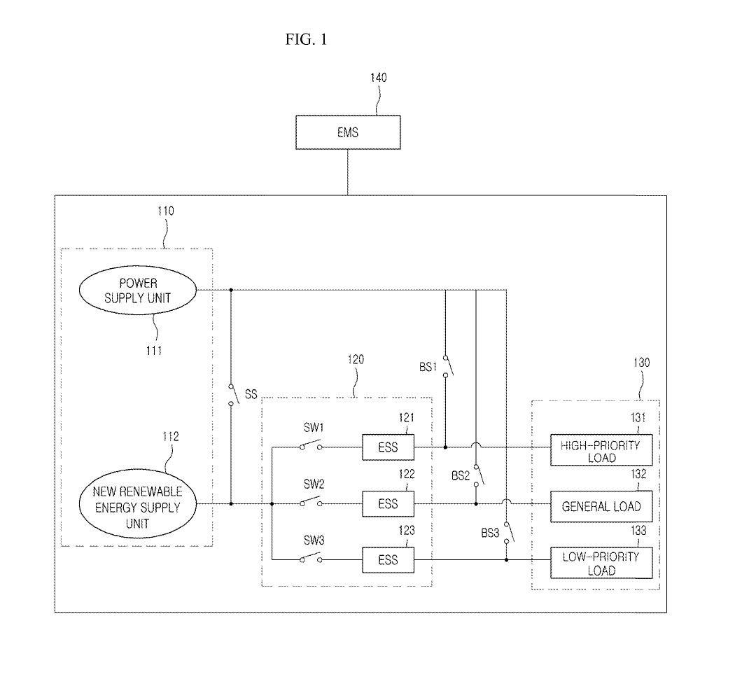

Hereinafter, preferred embodiments of the present invention will be described in detail with reference to the accompanying drawings. FIG. 1 is a schematic configuration diagram illustrating a microgrid system according to an embodiment of the present invention. Referring to FIG. 1, the microgrid system may include a power supply unit 110, a power storage unit 120, a load unit 130, and an energy management system (EMS) 140.

The power supply unit 110 generates power supplied to loads 131, 132, and 133 of the load unit 130. The power supply unit may include a system power supply unit 111 and a new renewable energy supply unit 112.

The system power supply unit 111 may be connected to the load unit 130 via a bypass or connected to the power storage unit 120. Bypass switches BS1, BS2, and BS3 may be located between the system power supply unit and each of the loads 131, 132, and 133.

For example, when a sum of power produced by the system power supply unit 111 and new renewable energy supply unit 112 is the same or slightly larger than a current power consumption of the load unit 130 but a difference between the sum of power and the power consumption is less than a predetermined value, the system power supply unit may be connected to the load unit via a bypass. Similarly, when the future predicted power produced by the system power supply unit and new renewable energy supply unit is the same or slightly larger than a predicted power consumption of the load unit but a difference between the sum of predicted power and the predicted power consumption is less than a predetermined value, the system power supply unit may be connected to the load unit via a bypass.

On the other hand, when the current or predicted power produced by the system power supply unit 111 and new renewable energy supply unit 112 is larger than the current power consumption of the load unit 130 and a difference between the current or predicted power produced and the current power produced is a threshold value or larger, it is determined that residual power is generated and the corresponding residual power is stored in the power storage unit 120. To accomplish this, the system power supply unit and the power storage unit may be selectively connected via a system switch SS.

The new renewable energy supply unit 112 produces energy using solar power, wind power, geothermal power, tidal power, or the like, and supplies the produced energy to the load unit 130. The supply of power to the load unit may be performed via the power storage unit 120.

The power storage unit 120 may include a plurality of energy storage systems (ESSs) 121, 122, and 123. As will be described later, the load unit 130 may be classified into a plurality of groups and the ESSs may be connected to the plurality of groups for each classification.

The load unit 130 may be classified into a high-priority load 131, a general load 132, and a low-priority load 133 with each of the loads connected to one of the ESSs. The high-priority load 131 may include emergency lighting, commercial facilities, and the like and the general load may include a general household load. The low-priority load may include a load whose operation can be stopped in an emergency, such as for a desalination facility, a garbage incineration plant, or the like.

The high-priority load 131, the general load 132, and the low-priority load 133 are merely examples and the load unit 130 may be further classified according to circumstances of the corresponding region. Since power should be constantly supplied to the high-priority load whenever possible, it is preferable that the high-priority load be connected to the system power supply unit 111 via a bypass. Meanwhile, it is preferable that a charged power of the ESS 121 for supplying power to the high-priority load be maintained at the highest value.

The EMS 140 manages and monitors the supply and use of energy in a smart grid system. The EMS may check the state (for example, power quantity, and the like) of the power supplied from the power supply unit 110 in real-time and whether power failure of the power supplied from the power supply unit occurs. For this, the EMS may perform two-way communication with the system power supply unit 111 and the new renewable energy supply unit 112 included in the power supply unit in real-time.

The EMS 140 may also check power storage states of each of the ESSs 121, 122, and 123 included in the power storage unit 120 in real-time, for example by checking a state of charge (SoC) of each of the ESSs. The EMS 140 may also check the current power consumption in the load unit 130 in real-time and determine a future predicted power.

The EMS 140 may enable power produced from the power supply unit 110 to be selectively stored in the power storage unit 120. The EMS may control the corresponding residual power to be stored in the power storage unit when a total power quantity supplied from the power supply unit is larger by at least a threshold amount than a total power consumption quantity in the load 130 or when the total power quantity supplied from the power supply unit is larger by at least a threshold amount than a predicted power consumption quantity in the load unit. That is, the EMS controls the residual power to be stored in the power storage unit when a determined total power quantity supplied from the power supply unit is larger than a power quantity currently required to be supplied to the load unit and a difference between the total power quantity and the required power quantity is at least a threshold amount.

The EMS 140 first determines whether an ESS among the plurality of ESSs 121, 122, 123 included in the power storage unit 120 has an SoC less than an allowable minimum value. The SoC of the ESSs should be maintained within an allowable range to prevent damage to and a reduction in service life of the ESSs.

The minimum level of the allowable SoC may vary depending on the application field. Operation should be performed for an SoC between a minimum of 20% and a maximum of 100% (fully charged state) for a field in which battery operation time is important. A range of the SoC between a minimum of 30% and a maximum of 70% is required for a field that requires maximum battery life.

Therefore, it is important to be within the range of the maximum and minimum SoC. The EMS 140 checks the SoC of each of the ESSs 121, 122, 123 of the power storage unit 120 in real-time to determine whether ESSs exist whose SoC is less than an allowable minimum value and preferentially charges ESSs having a determined SoC less than the allowable minimum value with the residual power. The ESSs control the residual power to be preferentially stored in the ESSs according to a priority of the loads in the load unit 130 when the SoCs of all of the ESSs are at least the allowable minimum value.

The residual power may be preferentially charged to the ESS 121 connected to the high-priority load 131 and then the residual power may be charged to the ESSs 122 and 123 connected to the general load 132 and the low-priority load 133. A first switch SW1 that connects the ESS 121 for supplying power to the high-priority load 131 may be turned on first and then a second switch SW2 and a third switch SW3 may be turned on such that power is sequentially charged to the ESSs according to the load priority. This will be described in more detail later.

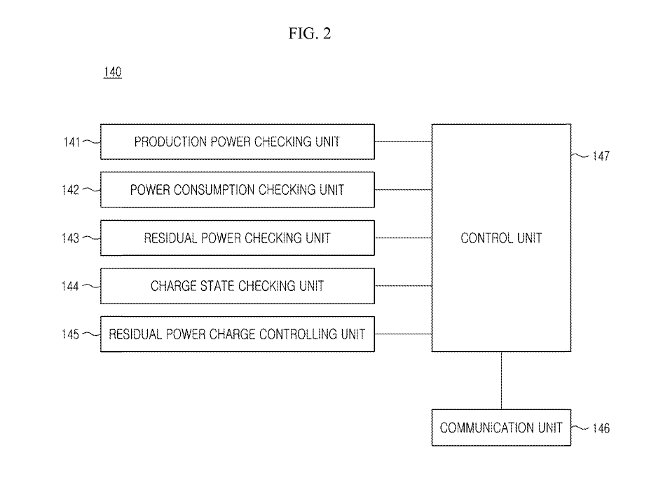

FIG. 2 is a diagram illustrating an internal configuration and operation of the EMS 140 according to an embodiment of the present invention. As illustrated in FIG. 2, the EMS may include a production power checking unit 141, a power consumption checking unit 142, a residual power checking unit 143, a charge state checking unit 144, a residual power charge controlling unit 145, a communication unit 146, and a control unit 147, which may be program modules provided inside the EMS. These program modules may be included in the EMS 140 in the form of an operating system (OS), an application program module, or other program modules and may be physically stored in various well-known storage devices or a remote storage device that communicates with the EMS. The program modules may perform specific operations described later or include a routine, a sub-routine, a program, an object, a component, a data structure, and the like that execute specific abstract data types but are not limited thereto.

The production power checking unit 141 determines a power quantity produced by the power supply unit 110 in real-time. The production power checking unit may determine the power quantity produced by the power supply unit by calculating a sum of the power quantity supplied by the system power supply unit 111 and the power quantity supplied by the new renewable energy supply unit 112.

The production power checking unit 141 may additionally determine and analyze future predicted power quantities of the system power supply unit 111 and the new renewable energy supply unit 112 and the likelihood of the predicted production power quantities. The production power checking unit may further determine whether power failure of the system power occurs.

The power consumption checking unit 142 determines a power consumption quantity in the load unit 130 in real-time. The power consumption checking unit may determine a power consumption quantity based upon a sum of the power consumption quantities of each of the high-priority load 131, the general load 132, and the low-priority load 133 in real-time. The power consumption checking unit may additionally determine and analyze a future predicted power consumption quantity of the load unit and the likelihood of the predicted power consumption quantity.

The residual power checking unit 143 determines presence or absence of residual power based on the determinations of the production power checking unit 141 and the power consumption checking unit 142. Specifically, the total power quantity produced by the power supply unit 110 and the total power quantity consumed by the load unit 130 are compared. The EMS 140 supplies power stored in the power storage unit 120 to the load unit when the total power quantity produced by the power supply unit is smaller than the total power quantity consumed by the load unit.

The ESSs 121, 122, and 123 may supply power to the connected high-priority load 131, general load 132, and low-priority load 133. According to another embodiment, the energy supplied from the ESSs may be controlled to be integrated such that the required power may be stably supplied to the high-priority load, general load, and low-priority load in the stated order.

For example, power stored in the other ESSs may be supplied for operation of the high-priority load when the power quantity stored in the ESS for supplying power to the high-priority load is insufficient (less than a threshold value). A switch (not shown) for mutually integrating and switching output power may be provided between the ESSs in order to accomplish this.

The residual power checking unit 143 determines that residual power is present when the total power quantity produced by the power supply unit 110 is larger by at least the threshold value than the total power quantity consumed in the load unit 130. Similarly, the residual power checking unit may determine that the residual power is present even when the predicted production power quantity of the power supply unit is larger by at least the threshold value than the predicted power consumption in the load unit.

In other words, the residual power checking unit 143 determines whether the total production power quantity is larger by at least the threshold value than the power quantity required for operation of the load unit 130. The threshold value may be determined according to regional characteristics.

Normal operation of the load unit 130 may be impossible according to a measurement error or an unexpected condition if the residual power is unconditionally stored even though the total power quantity produced by the power supply unit 110 is larger than the total power quantity consumed in the load unit. Therefore, it is preferable that the residual power is generated only when the total production power quantity is larger by at least the threshold value than the total power consumption quantity.

The charge state checking unit 144 determines an SoC of each of the ESSs 121, 122, and 123. As described previously, the ESSs should perform charge and discharge operations within a range of an allowable SoC in order to ensure an operating life. The charge state checking unit determines whether the ESSs are all present within the range of the allowable SoC and whether ESSs with SoCs less than an allowable minimum value are present.

The residual power charge controlling unit 145 controls the residual power to be stored in the ESSs 121, 122, and 123 when the residual power checking unit 143 determines that the residual power is present. First, the residual power may be preferentially charged to the ESSs determined by the charge state checking unit 144 to have SoCs less than the allowable minimum value.

The minimum value of the allowable SoC may be set differently depending on the corresponding region or condition and based on a type of load. For example, the minimum value of the allowable SoC may be set high in the ESS connected to the high-priority load.

The residual power charge controlling unit 145 preferentially stores power in the ESS 121 for supplying power to the high-priority load 131 while storing the residual power in the other ESSs 122, 123 when the residual power is charged to ESSs with SoCs less than the allowable minimum value for a predetermined time such that the SoCs of all of the ESSs are in the allowable range.

The residual power charge controlling unit 145 may store power in the ESSs 122 and 123 for supplying power to loads 132 and 133 having the next highest priorities when the ESS 121 for supplying power to the high-priority load 131 is fully charged. The residual power charge controlling unit may start to charge the ESSs 122, 123 when the SoC of the ESS for supplying power to the high-priority load is at least a threshold value (for example, 70%).

Additionally, a ratio of power stored in each of the ESSs 121, 122, and 123 may be different. For example, 50% of the residual power may be stored in the ESS connected to the high-priority load 131, 30% of the residual power may be stored in the ESS connected to the general load 132, and the remaining 20% of residual power may be stored in the ESS connected to the low-priority load 133.

The communication unit 146 enables the EMS 140 to receive information from the power supply unit 110 related to a current state of each of the power supply unit, the power storage unit 120, the load unit 130, and the power storage unit 120, and transmit control commands by enabling the EMS 140 to communicate with an external device such as the power supply unit, the power storage unit, the load unit. The control unit 147 may control a flow of data among the production power checking unit 141, the power consumption checking unit 142, the residual power checking unit 143, the charge state checking unit 144, the residual power charge controlling unit 145, the communication unit 146, and the control unit 147 by controlling each of the production power checking unit, the power consumption checking unit, the residual power checking unit, the charge state checking unit, the residual power charge controlling unit, and the communication unit to perform their unique functions.

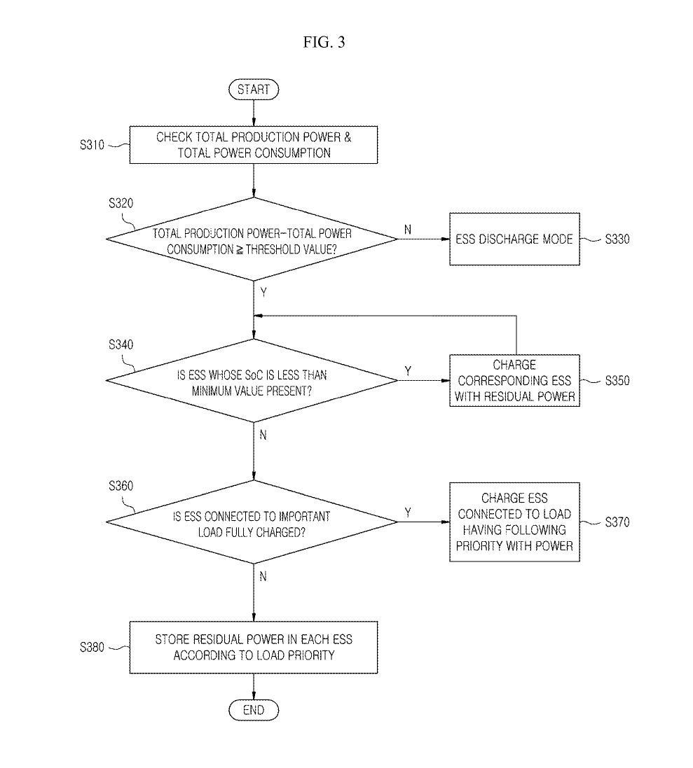

FIG. 3 is a flowchart illustrating a power storage method for an ESS 140 according to an embodiment of the present invention. Referring to FIGS. 1 and 3, in operation S310, the EMS determines a current total production power of the power supply unit 110 and a total current power consumption of the load unit 130. As described previously, the EMS may determine the current total production power and current total power consumption and also determine a predicted production power and predicted power consumption.

In operation S320, the EMS 140 determines whether the total production power is larger than the total power consumption and whether a difference between the total production power and the total power consumption is at least a threshold value. In operation S330, the EMS switches the ESSs 121, 122, and 123 of the power storage unit 120 into a discharge mode or maintains the ESSs when the total production power is determined as smaller than the total power consumption or the determined total production power is larger by less than the threshold value than the determined total power consumption such that the loads may be operated with the currently charged power. The high-priority load 131 may be connected to the system power supply unit 111 via a bypass.

In operation S340, the EMS 140 determines whether an ESS whose SoC is less than the allowable minimum value exists among the ESSs 121, 122, and 123 of the power storage unit 120 when the total production power is determined as larger by at least the threshold than the total power consumption in operation S320. In operation S350, the EMS charges the residual power of any ESS determined as having an SoC less than the allowable minimum value. The EMS 140 controls the residual power to be charged from the ESS 121 connected to the high-priority load 131 when the SoC of all of the ESSs are determined within the allowable range.

In operation S360, the EMS 140 determines whether the ESS 121 for supplying power to the high-priority priority load 131 is fully charged. The residual power may be sequentially stored in the ESSs 122 and 123 connected to loads having the next higher priorities, specifically general load 132 and the low-priority load 133, when it is determined that the ESS for supplying power to the high-priority load is fully charged. In contrast, in operation S380, the residual power may be preferentially charged to the ESS connected to the high-priority load and the residual power may be sequentially stored in the ESSs for supplying power to the other loads according to the priority of the loads when it is determined in operation S360 that the ESS for supplying power to the high-priority load is not fully charged.

As described previously, the ESS 121 connected to the high-priority load 131 may be fully charged and then energy may be stored in the ESSs 122, 123 connected to the loads 132, 133 having the next highest priorities. Additionally, power having a predetermined ratio may be charged to the ESS connected to the high-priority load and then energy may be stored in the ESSs connected to the loads having the next highest priorities. Furthermore, the residual power may be divided according to a fixed ratio such that power having a larger ratio may be stored in the ESS connected to the highest priority load.

As another example, a residual power charging process may be controlled such that the ESS connected to the load having the highest priority has a highest SoC. For example, the ESS 121 connected to the high-priority load 131 may perform a charge operation such that the corresponding SoC is 90%, the ESS 122 connected to the general load 132 may perform a charge operation such that the corresponding SoC is 70% and the ESS 123 connected to the low-priority load may perform a charge operation such that the corresponding SoC is 60%.

According to the present invention, residual power of the produced power may be preferentially stored in the ESS 121 connected to the high-priority load 131 such that the corresponding SoC has high availability and utilization may always be maintained at a high state. Further according to the present invention, residual power of the microgrid may be preferentially stored in the ESS connected to the load having the highest priority among the plurality of ESSs and, therefore, power may be stably supplied to the load having the highest priority in an emergency situation. Moreover according to the present invention, power may be preferentially stored in the ESS for supplying power to the high-priority load in advance and, therefore, power may be stably supplied to the high-priority load without a retroactive control method.

The methods according to various embodiments of the present invention may be implemented in the form of software readable by various computer systems and recorded in a computer-readable recording medium. The computer-readable recording medium may separately include program commands, local data files, local data structures, etc. or include a combination of them.

The computer-readable medium may be specially designed and configured for the present invention, or known and available to those of ordinary skill in the field of computer software. Examples of the computer-readable recording medium include magnetic media, such as a hard disk, a floppy disk, and a magnetic tape, optical media, such as a CD-ROM and a DVD, magneto-optical media, such as a floptical disk, and hardware devices, such as a ROM, a RAM, and a flash memory, specially configured to store and perform program commands.

Examples of the program commands may include high-level language codes executable by a computer using an interpreter, etc. as well as machine language codes made by compilers. Such a hardware apparatus may be configured to operate in one or more software modules, or vice versa in order to perform the operation of the present invention.

It will be apparent to those skilled in the art that various modifications can be made to the described exemplary embodiments of the present invention without departing from the spirit or scope of the invention. Therefore, it is intended that the present invention cover all such modifications provided they come within the scope of the appended claims and their equivalents.

What is claimed is:

1. A power distribution method for an energy management system (EMS), the method comprising:
determining a total quantity of power currently available in a power supply;
determining a quantity of power currently required by a plurality of loads each associated an energy storage system (ESS) of a plurality of energy storage systems ESSs;
determining a quantity of residual power currently available based on the total quantity of power currently available and the quantity of power currently required; and
charging the ESS associated with one of the plurality of loads determined as having a highest priority with the total power currently available while charging other ESSs associated with the other of the plurality of loads with the residual power currently available.

2. The method of claim 1, wherein charging the other ESSs comprises:
determining an ESS associated with the other of the plurality of loads that has a state of charge (SoC) less than a minimum allowable SoC; and
charging the determined ESS first with the residual power currently available.

3. The method of claim 1, further comprising:
determining a priority for each of the plurality of loads; and
sequentially charging the ESS associated with each of the plurality of loads according to the determined priority.

4. The method of claim 3, wherein sequentially charging the ESS comprises:
charging a first ESS associated with a load of the plurality of loads determined as having a highest priority; and
charging the ESSs associated with the other loads of the plurality of loads determined as having lower priorities after a state of charge (SoC) of the first ESS reaches a predetermined minimum value.

5. The method of claim 3, wherein sequentially charging the ESS comprises:
charging an ESS associated with a load of the plurality of loads determined as having a highest priority with a higher percentage of the residual power currently available by allocating the residual power according to a fixed ratio.

6. The method of claim 5, wherein:
the plurality of loads consist of a high-priority load, a general load and a low-priority load; and
the fixed ratio allocates 50% of the residual power currently available to the high priority load, allocates 30% of the residual power currently available to the general load and allocates 20% of the residual power currently available to the low-priority load.

7. The method of claim 3, wherein sequentially charging the ESS comprises:
charging the ESS associated with a load of the plurality of loads determined as having a highest priority such that the ESS has a higher state of charge (SoC) than ESSs associated with the other of the plurality of loads.

8. The method of claim 1, wherein determining the quantity of residual power currently available comprises:
determining that the total quantity of power currently available exceeds the quantity of power currently required by at least a threshold value.

9. The method of claim 1, further comprising:
switching the plurality of ESSs to a discharge mode or maintaining the plurality of ESSs at a current charge level when it is determined that no quantity of residual power is currently available.

10. The method of claim 9, wherein the discharge mode comprises:
determining that a charge level of the ESS associated with one of the plurality of loads determined as having the highest priority is insufficient; and
allocating power of at least one ESS associated with another of the plurality of loads determined as having a lower priority to charge the ESS associated with the one of the plurality of loads determined as having the highest priority.

11. A microgrid energy measurement system comprising:
a power determination apparatus configured to determine a total quantity of power currently available in a power supply;
a power consumption determination apparatus configured to determine a quantity of power currently required by a plurality of loads each associated an energy storage system (ESS) of a plurality of energy storage systems ESSs;
a residual power determination apparatus configured to determine a quantity of residual power currently available based on the total quantity of power currently available and the quantity of power currently required; and
a control apparatus configured to charge the ESS associated with one of the plurality of loads determined as having a highest priority with the total power currently available while charging other ESSs associated with the other of the plurality of loads with the residual power currently available.

12. The energy management system of claim 11, further comprising:
a state of charge (SoC) apparatus configured to determine an ESS associated with the other of the plurality of loads that has an SoC less than a minimum allowable SoC,
wherein the control apparatus is further configured to charge the determined ESS first with the residual power currently available.

13. The energy management system of claim 11, wherein the control apparatus is further configured to:
determine a priority for each of the plurality of loads; and
sequentially charge the ESS associated with each of the plurality of loads according to the determined priority.

14. The energy management system of claim 13, wherein sequentially charging the ESS comprises:
charging a first ESS associated with a load of the plurality of loads determined as having a highest priority; and
charging the ESSs associated with the other loads of the plurality of loads determined as having lower priorities after a state of charge (SoC) of the first ESS reaches a predetermined minimum value.

15. The energy management system of claim 13, wherein sequentially charging the ESS comprises:
charging the ESS associated with a load of the plurality of loads determined as a highest priority with a higher percentage of the residual power currently available by dividing the residual power according to a fixed ratio.

16. The energy management system of claim 15, wherein:
the plurality of loads consist of a high-priority load, a general load and a low-priority load; and
the fixed ratio allocates 50% of the residual power currently available to the high priority load, allocates 30% of the residual power currently available to the general load and allocates 20% of the residual power currently available to the low-priority load.

17. The energy management system of claim 13, wherein sequentially charging the ESS comprises:
charging the ESS associated with a load of the plurality of loads determined as having a highest priority such that the ESS has a higher state of charge (SoC) than ESSs associated with the other of the plurality of loads.

18. The energy management system of claim 11, wherein determining the quantity of residual power currently available comprises:
determining that the total quantity of power currently available exceeds the quantity of power currently required by at least a threshold value.

19. The energy management system of claim 11, wherein the control apparatus is further configured to switch the plurality of ESSs to a discharge mode or maintain the plurality of ESSs at a current charge level when it is determined that no quantity of residual power is currently available.

20. The energy management system of claim 19, wherein the discharge mode comprises:
determining that a charge level a of the ESS associated with one of plurality of loads determined as having the highest priority is insufficient; and
allocating power of at least one ESS associated with another of the plurality of loads determined as having a lower priority to charge the ESS associated with the one of the plurality of loads determined as having the highest priority.
